(19) United States
(12) Patent Application Publication
(10) Pub. No.: US 2009/0115505 A1
(43) Pub. Date: May 7, 2009

(54) SEMICONDUCTOR DEVICE WITH CONTROLLABLE DECOUPLING CAPACITOR

(75) Inventors: Hyung-Dong LEE, Kyoungki-do (KR); Jun-Ho LEE, Kyoungki-do (KR); Dong-Hwee KIM, Kyoungki-do (KR); Hwa-Yong YANG, Kyoungki-do (KR)

Correspondence Address: MANNAVA & KANG, P.C., 11240 WAPLES MILL ROAD, Suite 300, FAIRFAX, VA, 22030, US

(73) Assignee: Hynix Semiconductor, Inc., Kyoungki-Do (KR)

(21) Appl. No.: 12/136,454

(22) Filed: Jun. 10, 2008

(30) Foreign Application Priority Data
Nov. 2, 2007 (KR) 10-2007-0111348

(51) Int. Cl. G05F 1/46

(52) U.S. Cl. 327/581

(57) ABSTRACT

Semiconductor device with a controllable decoupling capacitor includes a decoupling capacitor connected between a power voltage terminal and a ground terminal and a switching unit configured to enable/disable the decoupling capacitor in response to a control signal. According to another aspect, a semiconductor device with a controllable decoupling capacitor includes multiple circuits, decoupling capacitors being connected in parallel to each of the circuits and switching units being configured to enable/disable the decoupling capacitors in response to control signals.

### CROSS-REFERENCE TO RELATED APPLICATIONS

The present invention claims priority of Korean patent application number 10-2007-0111348, filed on Nov. 2, 2007, which is incorporated by reference in its entirety.

### BACKGROUND OF THE INVENTION

The present invention relates to a decoupling capacitor suppressing a high frequency noise in a semiconductor device, and more particularly, to technology for improving screening ability while a semiconductor device is tested through control of a decoupling capacitor.

In a semiconductor device, a decoupling capacitor is a capacitor used for removing an on-chip high frequency noise. Particularly, the decoupling capacitor prevents a portion of the semiconductor device that supplies a voltage from being influenced by a noise caused by an internal/external condition.

Most of semiconductor devices include lots of circuits generating a voltage from the inside of the semiconductor besides a voltage supplied from the outside. For example, a semiconductor memory device has lots of circuits for generating voltages of a core voltage VCORE, a backbias voltage VBB, and a high voltage VPP which are internally generated voltages besides a power voltage VDD, which is a voltage received from the outside. Internal circuits operate using voltages generated by these circuits.

The decoupling capacitor stabilizes voltages supplied to the internal circuits without an influence of other parts.

FIG. 1 is a circuit diagram illustrating a decoupling capacitor applied to a conventional semiconductor device.

Decoupling capacitors C1 and C2 are connected between a power voltage terminal POWER and a ground terminal GND to suppress the high frequency noise of a chip. Current sources 101 and 102 in the drawing represent circuits consuming a current inside the chip, respectively. For example, each of the current sources 101 and 102 can be a charge pumping circuit, an output driver circuit, or a decoding circuit inside the chip.

Though the decoupling capacitors C1 and C2 can be connected between the power voltage terminal POWER and the ground terminal GND, they can be connected in parallel to each of the circuits 101 and 102 inside the chip to stabilize the power of each circuit.

Use of the decoupling capacitors C1 and C2 reduces a high frequency noise and reduces a dynamic IR drop to improve the operation characteristic of the chip.

However, deterioration in a jitter characteristic generated on the chip by the use of the decoupling capacitors C1 and C2 is difficult to screen through an automatic testing equipment (ATE).

That is, since the decoupling capacitors C1 and C2 screen signal racing or jitter caused by deterioration in a jitter characteristic, the ATE cannot recognize these limitations.

### SUMMARY OF THE INVENTION

Embodiments of the present invention are directed to securing a screening ability during a test by allowing a control of a decoupling capacitor.

In accordance with an aspect of the invention, a decoupling capacitor is connected between a power voltage terminal and a ground terminal and a switching unit is configured to enable/disable the decoupling capacitor in response to a control signal.

In accordance with another aspect of the invention, multiple circuits have decoupling capacitors connected in parallel to each and switching units are configured to enable/disable the decoupling capacitors in response to control signals.

### BRIEF DESCRIPTION OF THE DRAWINGS

FIG. 1 is a circuit diagram illustrating a decoupling capacitor applied to a conventional semiconductor device.

FIG. 2 is a circuit diagram of a semiconductor device in accordance with an embodiment of the present invention.

FIG. 3 is a circuit diagram of a semiconductor memory device in accordance with another embodiment of the invention.

FIG. 4 is a circuit diagram of a semiconductor device in accordance with another embodiment of the invention.

### DESCRIPTION OF SPECIFIC EMBODIMENTS

Hereinafter, a semiconductor device with a controllable decoupling capacitor in accordance with the present invention will be described in detail with reference to the accompanying drawings.

Hereinafter, a most preferred embodiment of the invention will be described in detail with reference to the accompanying drawings so that those skilled in the art can easily carry out the spirit of the invention.

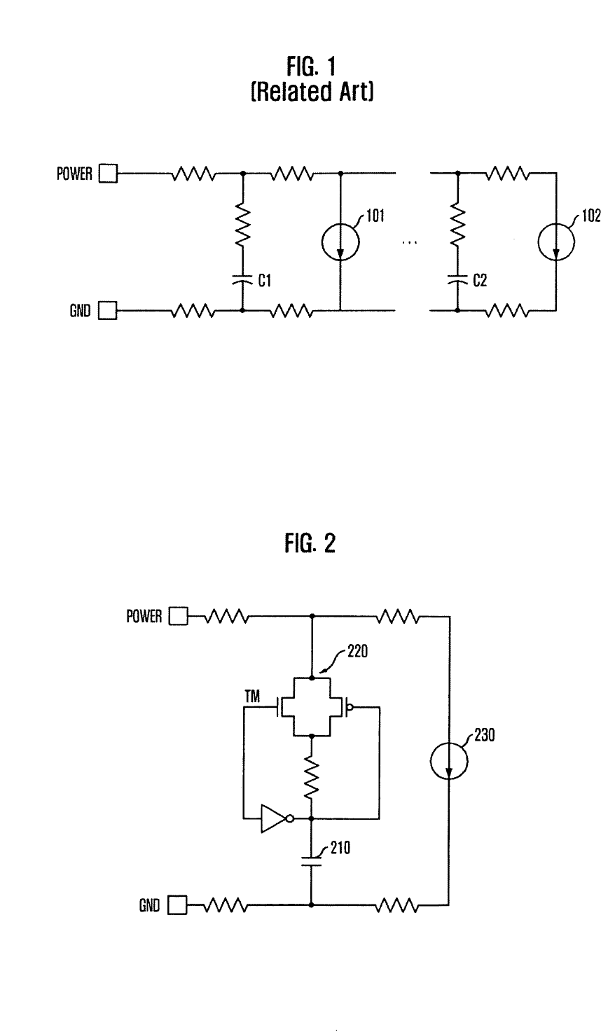

FIG. 2 is a circuit diagram of a semiconductor device in accordance with an embodiment of the invention.

Referring to FIG. 2, the semiconductor device includes a decoupling capacitor 210 connected between a power voltage terminal POWER and a ground terminal GND. The device also includes a switching unit 220 enabling/disabling the decoupling capacitor 210 in response to a control signal TM. A current source 230 represents circuits inside a chip consuming a current, i.e. 230 represents a load.

The decoupling capacitor 210 is connected between the power voltage terminal POWER and the ground terminal GND to allow the power voltage terminal POWER to maintain a constant voltage even when an internal/external noise occurs, thereby guaranteeing the stable operation of the semiconductor device.

The switching unit 220 cuts or connects one end of the decoupling capacitor 210 in response to a control signal TM to enable/disable the decoupling capacitor 210. Therefore, the decoupling capacitor 210 can be disabled to improve a screening ability during a test using an ATE. Therefore, a stable operation free of a high frequency noise can be guaranteed during a normal operation, not a test. Improvement in the screening ability also can be achieved during a test. The switching unit 220 can include one or more transistors each receiving a control signal TM through its gate to enable/disable the capacitor 210 using its drain-source path. For example, the switching unit 220 can include one N-metal oxide semiconductor (NMOS) transistor or one P-metal oxide semiconductor (PMOS) transistor. Also, the switching unit 220 can be realized in the form of a transmission gate (TG) where a PMOS transistor and an NMOS transistor are provided in a pair.

A control signal TM can be generated in the same manner in which a general test mode signal is generated. For example, the logic value of a control signal TM can be changed by setting of a mode register set, or a control signal TM can be designed such that it is received from the outside using a specific pin of a semiconductor chip. Since generation of the signal would be carried out in various ways depending on a design by those skilled in the art, detailed description thereof is omitted.

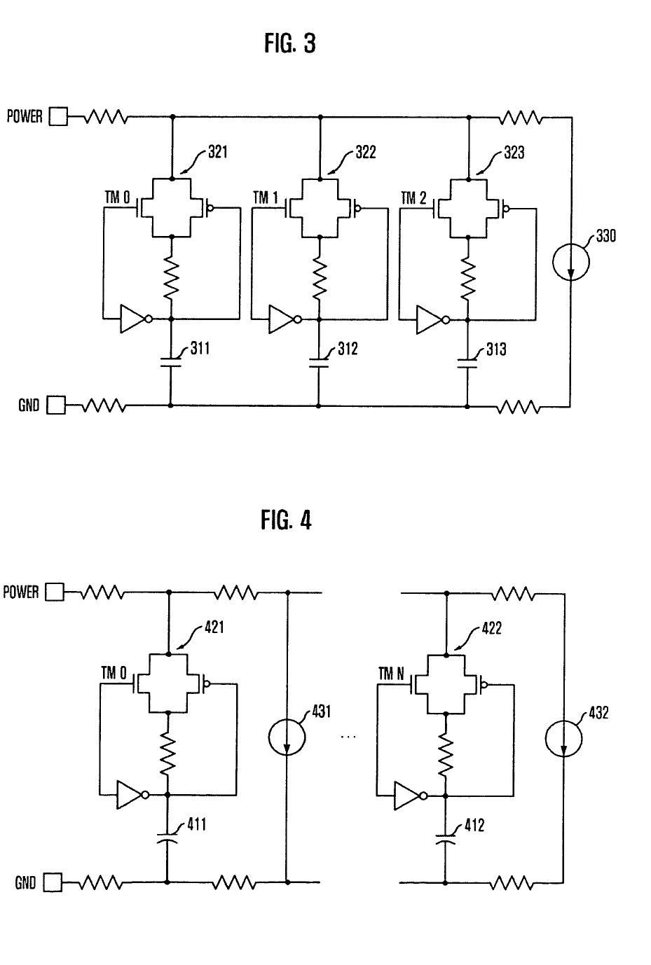

FIG. 3 is a circuit diagram of a semiconductor memory device in accordance with another embodiment of the invention.

Unlike the embodiment of FIG. 2, the embodiment of FIG. 3 includes decoupling capacitors 311, 312, and 313, and switching units 321, 322, and 323. The capacitance of all the decoupling capacitors 311, 312, and 313 are controlled by the switching units. The current source 330 represents a load.

That is, in the embodiment of FIG. 2, only the decoupling capacitor 210 is simply enabled/disabled, but in the embodiment of FIG. 3, the logic levels of control signals TM 0, TM 1, and TM 2 are controlled to enable some of the decoupling capacitors 311, 312, and 313 connected in parallel, and to disable some of the decoupling capacitors 311, 312, and 313, so that the capacitance of all the decoupling capacitors 311, 312, and 313 can be controlled.

By doing so, the capacitance of the decoupling capacitors 311, 312, and 313 can be changed according to control signals TM 0, TM 1, and TM 2 even after a semiconductor device is manufactured, so that lots of advantages such as setting optimum entire capacitance of the decoupling capacitors 311, 312, and 313 for each operation frequency can be provided. Of course, the control signals TM 0, TM 1, and TM 2 can be controlled to disable all the decoupling capacitors 311, 312, and 313.

FIG. 4 is a circuit diagram of a semiconductor device in accordance with another embodiment of the invention.

Referring to FIG. 4, the semiconductor device includes circuits 431 and 432; decoupling capacitors 411 and 412 connected in parallel to the plurality of circuits 431 and 432, respectively; and switching units 421 and 422 enabling/disabling the decoupling capacitors 411 and 412 in response to control signals TM 0 and TM 1.

The embodiment of FIG. 4 differs from the embodiment of FIG. 2 in that the decoupling capacitors 411 and 412 are not simply disposed between a power voltage terminal POWER and a ground voltage terminal GND but are connected in parallel to the circuits 431 and 432 performing different functions, respectively. That is, each of the decoupling capacitors 411 and 412 in the embodiment of FIG. 4 suppresses a high frequency noise of a corresponding circuit.

The circuits 431 and 432 performing different functions, respectively, represent various circuits inside the semiconductor device (chip). For example, the current sources 431 and 432 of FIG. 4 can be delay locked loops (DLL), charge pumping circuits, decoder circuits, or output drivers.

The decoupling capacitors 411 and 412 suppress high frequency noises of these circuits 431 and 432, respectively. Also, the semiconductor device of the invention includes the switching units 421 and 422 enabling/disabling the decoupling capacitors 411 and 412. The decoupling capacitors 411 and 412 are enabled/disabled by the switching units 421 and 422, so that the decoupling capacitors 411 and 412 are enabled during a normal operation to suppress a high frequency noise, and disabled during a test to improve a screening ability.

All of control signals TM 0 and TM N controlling an enable/disable operation can be simultaneously controlled or controlled, individually. For example, all the control signals TM 0, TM N, . . . can be controlled to have the same level to simultaneously enable/disable all the decoupling capacitors 411 and 412. All of control signals TM 0, TM N, . . . can be individually controlled to enable some of the decoupling capacitors 411 and 412 and disable some of the decoupling capacitors 411 and 412. A method for controlling the control signals TM 0, TM N, . . . can be selectively designed depending on the characteristic of a semiconductor device to which the invention is applied.

The embodiment of FIG. 4 illustrates the control signals TM 0, TM N, . . . enable/disable only the decoupling capacitors 411 and 412. However, even the case where the decoupling capacitors 411 and 412 are provided to the circuits 431 and 432, respectively, can be designed such that the capacitance of the decoupling capacitors is controlled in a similar manner to in FIG. 3.

In this case, multiple decoupling capacitors and switching units are provided to each of the circuits 431 and 432 of FIG. 4 (decoupling capacitors and switching units as illustrated in FIG. 3 are provided to each circuit of FIG. 4). In this case, the capacitance of the decoupling capacitor can be controlled for each circuit.

Since decoupling capacitors can be enabled/disabled or the capacitance of the decoupling capacitors can be controlled in accordance with the invention, the screening ability can be increased during a test using an ATE.

Also, since the value of a decoupling capacitor can be changed, the capacitance of the decoupling capacitor can be properly set depending on the operation frequency of a semiconductor device.

While the invention has been described with respect to the specific embodiments, it will be apparent to those skilled in the art that various changes and modifications may be made without departing from the spirit and scope of the invention as defined in the following claims.

What is claimed is:

1. A semiconductor device, comprising a decoupling capacitor connected between a power voltage terminal and a ground terminal, and a switching unit configured to enable/disable the decoupling capacitor in response to a control signal.

2. The semiconductor device as recited in claim 1, wherein the control signal has a logic value determined by a mode register set.

3. The semiconductor device as recited in claim 1, wherein the control signal is input from outside of said device.

4. The semiconductor device as recited in claim 1, wherein the switching unit includes at least one transistor configured to receive the control signal through a gate to enable/disable the capacitor using a drain-source path.

5. A semiconductor device, comprising a plurality of decoupling capacitors and switching units, at least one of the decoupling capacitors connected between a power voltage terminal and a ground terminal, the switching units configured to enable/disable the decoupling capacitors in response to control signals, such that an entire capacitance of the decoupling capacitors is controlled by the control signals.

6. A semiconductor device, comprising a plurality of circuits, decoupling capacitors connected in parallel to each of the circuits, and switching units configured to enable/disable the decoupling capacitors in response to control signals.

7. The semiconductor device as recited in claim 6, wherein the control signals are controlled to have the same logic value to enable/disable the decoupling capacitors simultaneously.

8. The semiconductor device as recited in claim 6, wherein the control signals are individually controlled to enable a first plurality of the decoupling capacitors corresponding to a first plurality of the circuits, and to disable a second plurality of the decoupling capacitors corresponding to a second plurality of the circuits.

9. The semiconductor device as recited in claim 6, wherein each of the circuits is provided with respective said decoupling capacitors and respective said switching units, and the entire capacitance of the decoupling capacitors for each of the circuits is controlled by the switching units.

10. The semiconductor device as recited in claim 6, wherein the control signal has a logic value determined by a mode register set setting.

11. The semiconductor device as recited in claim 6, wherein the control signal is input from outside of the semiconductor device.
